(19) United States
(12) Patent Application Publication
(10) Pub. No.: US 2013/0005280 A1
(43) Pub. Date: Jan. 3, 2013

(54) METHOD FOR CONSTRUCTING A WIRELESS COMMUNICATION DEVICE TO ACHIEVE MOTION SENSING FUNCTION

(75) Inventors: Chun Kai Leung, Hong Kong (HK); Ka King Wong, Hong Kong (HK); Tik Shun Leung, Hong Kong (HK)

(73) Assignee: Hong Kong Applied Science and Technology Research Institute Company Limited, Hong Kong (HK)

(21) Appl. No.: 13/170,185

(22) Filed: Jun. 28, 2011

(51) Int. Cl. H04W 88/02

(52) U.S. Cl. 455/90.1

(57) ABSTRACT

A system for sensing motion and performing wireless communication, includes one or more antennas for transmitting and receiving wireless data communication signals and motion detection electromagnetic waves. One or more electrical switches switch among electrical paths activating frequency channel scanning, motion sensing, interference detection, and data communication. A motion sensor receiver receives motion detection electromagnetic waves. A transceiver generates both modulated RF signals for the wireless data communication and un-modulated RF signals for the motion detection. One or more processors process motion detection electromagnetic wave data and detected interference signal data as well as processing wireless communication data to and from the transceiver, controlling the one or more electrical switches, and providing commands to the transceiver.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates to wireless data communication systems and systems for motion sensing using electromagnetic waves. Particularly, the invention relates to electrical circuitry that performs the dual functions of wireless data communication and motion sensing in a serially time-allocated fashion.

### BACKGROUND

Traditionally, a wireless communication device, such as a WiFi network access point or adapter in a WiFi network, or a cellular phone in a cellular telecommunication network, is used for data or voice communication only. Separately, motion detection systems are usually implemented as standalone devices such as burglar alarm systems and speed check radar.

One technique of motion detection is based on the Doppler effect. The Doppler effect is the change of frequency of a wave for an observer moving relative to/away from the source of the wave. When the observer is moving closer to the source of the wave, the perceived frequency of the wave is higher, but lower when the observer is moving away from the source. The Doppler effect is also used in some types of radar. Almost all object surfaces can reflect electromagnetic waves. To detect a moving object, a radio wave beam is fired at the targeted object. The radio wave beam is reflected back towards the source. The wavelength of the reflected wave increases when the targeted object moves further from the source, and decreases when closer. By measuring each successive wave, the velocity of the targeted object can be calculated.

In some conventional home automation systems, electrical appliances such as lighting systems, air conditioners, etc. are connected to wireless communication devices. The most commonly used wireless communication systems use a Zigbee specification (a suite of high level communication protocols using small, low-power digital radios based on the IEEE802.15.4-2003 standard for Low-Rate Wireless Personal Area Networks (LR-WPANs)). In a Zigbee system, electrical appliances are controlled remotely by a handheld controller device or a computer. In order to save energy and enhance system flexibility, external motion sensors are also connected to electrical appliances that work together with the wireless communication devices. But such configuration usually incurs complex installation and higher cost. In more contemporary systems, since both wireless data communication and motion detection technologies involve the transmission and receipt of electromagnetic waves, efforts have been made to combine both into a single system. One can find a number of practical applications for such combined systems. For example, in lighting control, lights can be switched on and off by a wireless controller, and automatically shut off when no one is in the room. However, most such systems involved simply combining two disparate parts to form a single unit or specialized electrical circuitries resulting in high cost and/or high complexity. The other benefit from integrating a motion sensing function into a wireless communication device is that configuration parameters such as the detection range, sensitivity, frequency channels can be changed by using the same wireless controller used for wireless communication. That means no separate additional controller is needed for motion sensing. Also, since a motion sensing function is integrated into the wireless communication device, interactive operations with the environment for the motion sensing can be achieved. For example, by using the channel scanning function of the communication device, the motion sensing module can use different channels with different signal strengths, allowing multiple motion sensors to operate simultaneously in a small defined area without causing false motion detection.

In U.S. Pat. No. 6,084,530, a modulated backscatter sensor system is disclosed. The backscatter sensor system uses Radio Frequency Identification (RFID) Tags to facilitate the detection of movement of the tags that might be attached to the targeted objects. In this disclosure, the RFID Tag itself transmits RF signals, including analog data, to the sensor. Custom circuitries are built for the RFID data communication and Doppler signal analysis. Thus, this system is application-specific and implementable only with RFID technology. Also in this system, modulated carrier signals are used for motion sensing which are sensitive to interference.

U.S. Patent Application Publication No. 2008/0056390 discloses a method of estimating the Doppler frequency of a moving mobile communication device, and the speed of its movement. In this disclosure, the method is used in a cellular or WLAN communication network where there is at least one mobile communication device and multiple base stations. The wireless communication coverage, in which the mobile communication device can maintain adequate signal strength, is divided into zones. When traveling from zone to zone, the signal weakens and strengthens as the mobile communication device comes near to then moves away from the zero-crossings. The Doppler frequency is then calculated from the fading of preamble and pilot signals that are exchanged between the mobile communication device and the base stations. Thus, the motion sensing feature in this disclosure is specific to cellular or WLAN communication network technologies and can only detect the movement of mobile communication devices within the communication network.

Another kind of motion sensing involves embedding a gyrator within a mobile communication device such that the mobile device itself can detect its own movement and transmit such information to the base stations in the communication network. U.S. Patent Application Publication No. 2008/0238703 discloses such a system. However, this system cannot be used for detecting motions of random objects.

Thus there is a need in the art for improved wireless communication systems that include integrated motion detecting functions.

### SUMMARY

In accordance with an embodiment of the presently claimed invention, a wireless communication system is enhanced to include the additional function of a motion sensor. The presently claimed invention provides the motion sensing capability by improving upon conventional wireless communication components, avoiding the use of external components or having to combine two sets of components that are separately dedicated to wireless communication and motion detection. This reduces the cost and complexity of the system.

In addition, the presently claimed invention includes a transceiver with a single port for both transmitting and receiving RF signals. The transceiver is configured to send and receive data communication via modulated carrier signals, and can also bypass its modulator for the generation of un-modulated carrier signals for motion detection, thus functioning as the transmitter of a motion sensing signal. Un-modulated carrier signals are less susceptible to interference during motion sensing. To improve the accuracy of the motion sensing, the system, in one operational mode, detects interference signals by recognizing the environment noise floor in the detection area. In another operational mode, the system scans the environment for available frequencies, selecting the appropriate frequency for the motion sensing carrier signals. The advantage is that it allows multiple motion sensors in the same detection area while avoiding co-channel and adjacent channel interference.

In one embodiment, a processor, such as a digital signal processor (DSP), is used to process and analyze motion detection electromagnetic wave data and the detected interference signal data from a motion sensor receiver, process received wireless communication data from the transceiver, and control one or more electrical switches as well as control and supply outgoing communication data to the transceiver.

In accordance with various embodiments, the one or more electrical switches are for switching between electrical paths, activating the different operations including environment frequency channel scanning, motion sensing, interference detection, and wireless data communication signal transmission and receiving. In one embodiment, two electrical switches are used to create three electrical paths: the first electrical path connecting a first antenna to the transceiver then to the processor, enabling the operation of environment frequency channel scanning, and the operation of data communication; the second electrical path connecting the first antenna to a coupler and to the transceiver and then the processor, a second antenna to the motion sensor receiver, which is connected to the coupler, then to the processor, enabling the operation of motion sensing; the third electrical path connecting the second antenna to the motion sensor receiver, which is connected to the coupler, to the processor, the coupler connecting to the transceiver to the processor, enabling the operation of interference detection.

### BRIEF DESCRIPTION OF THE DRAWINGS

Embodiments of the invention are described in more detail hereinafter with reference to the drawings, in which

FIG. 1 shows a block diagram of an embodiment of a wireless communication system with motion sensing function;

FIG. 2 shows a block diagram of an embodiment of the wireless communication system with motion sensing function under Environment Frequency Channel Scanning Operational Mode and Data Communication Operational Mode;

FIG. 3 shows a block diagram of an embodiment of the wireless communication system with motion sensing function under Motion Detection Operational Mode;

FIG. 4 shows a block diagram of an embodiment of the wireless communication system with motion sensing function under Interference Detection Operational Mode; and

FIG. 5 shows a flow diagram of the operations of the wireless communication system with motion sensing function.

### DETAILED DESCRIPTION

In the following description, a wireless communication system with motion sensing function and the like and the method for constructing thereof are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

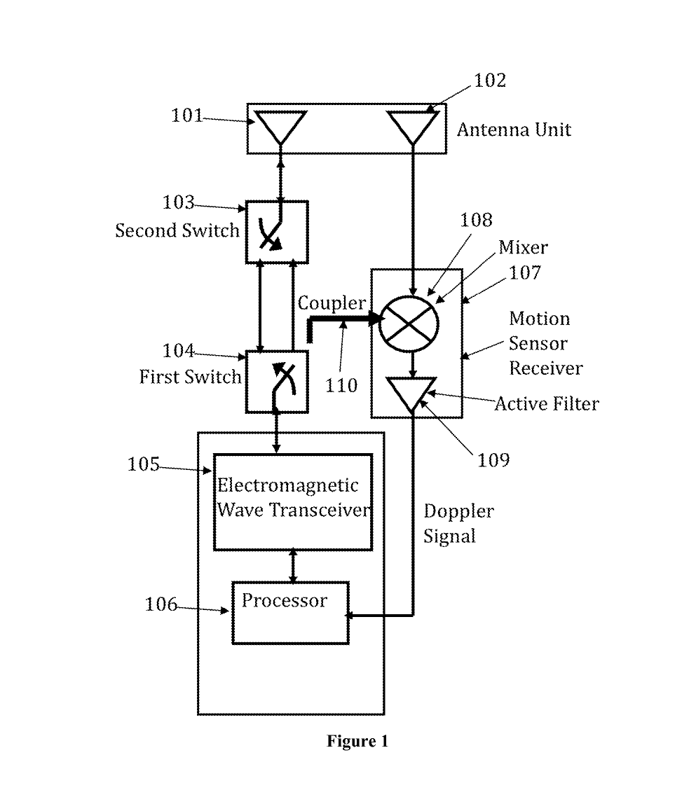

Referring to FIG. 1, two electrical switches 103 and 104 are used to create three electrical paths: the first electrical path connecting a first antenna 101 to a transceiver 105 then to a processor 106, enabling the operation of environment frequency channel scanning, and the operation of data communication; the second electrical path connecting the first antenna 101 to a coupler 110 and in parallel to the transceiver 105 then to the processor 106, a second antenna 102 is connected to a mixer 108 of a motion sensor receiver 107, which is connected to the coupler 110, then to an active filter 109 of the motion sensor receiver 107, the coupler 110 is connected to the transceiver 105 then to the processor 106, enabling the operation of motion sensing; the third electrical path connecting the second antenna 102 to the mixer 108 of the motion sensor receiver 107, which is connected to the coupler 110, then to the active filter 109 of the motion sensor receiver 107, the coupler 110 is connected to the transceiver 105 then to the processor 106, enabling the operation of interference detection.

### Environment Frequency Channel Scanning

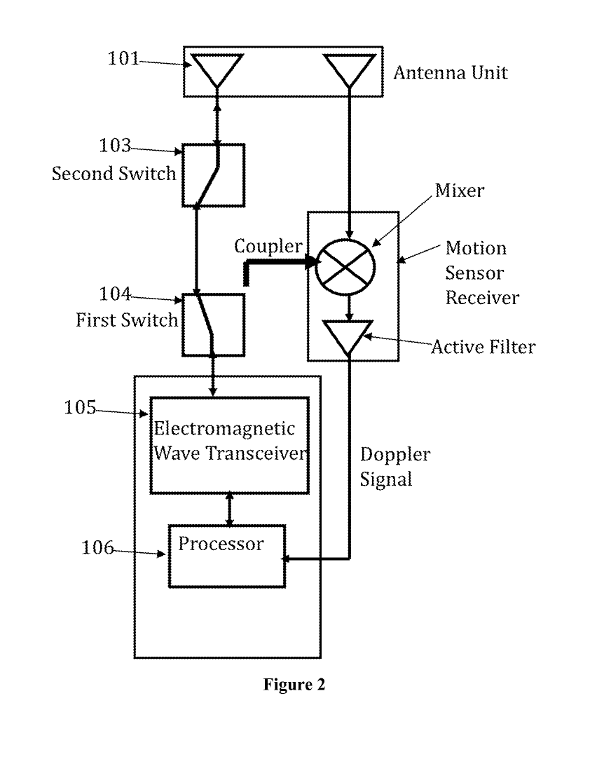

Referring to FIG. 2, in the Environment Frequency Channel Scanning operational mode, the wireless communication system with motion sensing function activates the electrical path connecting the first antenna 101 to the transceiver 105 then to the processor 106. The system scans through the frequency spectrum and compares the signals at each scanned frequency for their relative signal strengths. The processor 106 is configured to control the transceiver 105 to scan the frequency spectrum of the targeted detection area and to perform the frequency domain analysis on the received signals at each scanned frequency. The frequency with the relatively lower signal strengths is selected for use as a motion detection carrier signal frequency. This allows multiple motion sensors in the same detection area while avoiding co-channel and adjacent channel interference.

In accordance with one embodiment, the signal strength analysis conforms to the IEEE 802.11 standard, in which numerical values, called the Received Signal Strength Indicator (RSSI), represent the signal strength of scanned RF signals at the different frequencies. A detailed description of the IEEE 802.11 standard and RSSI is disclosed in Converting Signal Strength Percentage to dBm Values, WildPackets, Inc., November 2002; content of which is incorporated herein by reference in its entirety.

### Data Communication

Still referring to FIG. 2, in the Data Communication operational mode, the wireless communication system with motion sensing function activates the electrical path connecting the first antenna 101 to the transceiver 105 and then to the processor 106. The processor 106 provides the control signal and outgoing communication data to the transceiver 105. The transceiver 105 comprises an internal modulator and local oscillator for the generation of a modulated signal for wireless data communication. The processor 106 also processes the received communication data from the transceiver 105.

### Motion Sensing

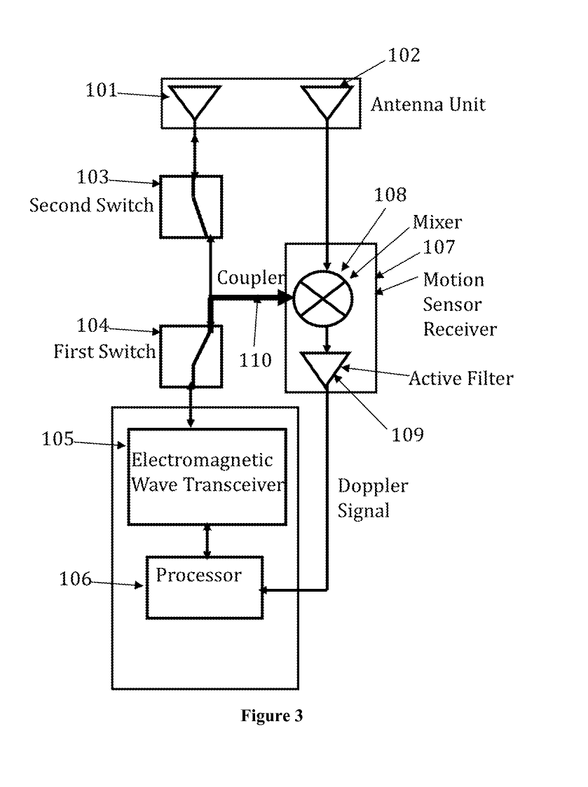

Referring to FIG. 3, in the Motion Sensing operational mode, the wireless communication system with motion sensing function activates the electrical path connecting the first antenna 101 to a coupler 110 and in parallel to the transceiver 105 then to the processor 106. A second antenna 102 is connected to a mixer 108 of a motion sensor receiver 107, which is connected to the coupler 110, then to an active filter 109 of the motion sensor receiver 107. The coupler 110 is connected to the transceiver 105 and then to the processor 106. The transceiver 105 functions as the transmitter of a motion sensing electromagnetic wave, bypassing its internal modulator, to generate un-modulated electromagnetic wave signals at the carrier frequency selected during the Environment Frequency Scanning operation for motion detection. The un-modulated electromagnetic wave signals are radiated from the first antenna 101. When the radiated electromagnetic wave signals are reflected back from object surfaces, they are received by the second antenna 102 and sent to the motion sensor receiver 107. The motion sensor receiver 107 includes the mixer 108 and active filter 109. The radiated electromagnetic wave signals generated by the transceiver 105 are also directed to the mixer 108 through the coupler 110. The reflected signals are mixed with the radiated signals in the mixer 108 then pass through the active filter 109 resulting in a Doppler signal. The Doppler signal is analyzed by the processor 106 using a short-time Fourier Transform or Time Domain analysis with an expected Doppler frequency of 1-25 Hz corresponding to the velocities of movements by human beings.

A short-time Fourier Transform is a signal processing technique often employed as the first step in analyzing a Doppler signal. The result of a short-time Fourier Transform on a Doppler signal is a spectrogram showing the frequency of a reflected RF wave over a short time window. Based on the pattern of the spectrogram, the presence of human motions can be determined. Details of the applications of short-time Fourier Transform analysis are disclosed in Otero, Michael, Application of continuous wave radar for human gait recognition, the MITRE Corporation, the disclosure of which is incorporated herein by reference in its entirety.

### Interference Detection

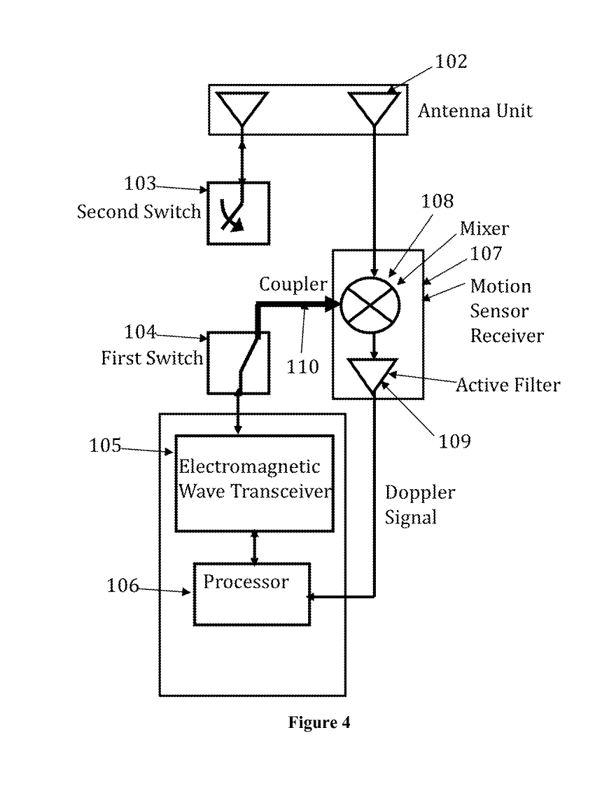

Referring to FIG. 4, in the Interference Detection operational mode, the wireless communication system with motion sensing function activates the electrical path connecting the second antenna 102 to the mixer 108 of the motion sensor receiver 107, which is connected to the coupler 110, then to the active filter 109 of the motion sensor receiver 107. The coupler 110 is connected to the transceiver 105 and then to the processor 106. Electromagnetic wave signals from the environment are received by the second antenna 102 and sent to the motion sensor receiver 107. The radiated electromagnetic wave signals generated by the transceiver 105 are also directed to the mixer 108 through the coupler 110. The environment signals are mixed with the radiated signals in the mixer 108, pass through the active filter 109 then are analyzed by the processor 106. Since the environment signals are not reflected signals of the electromagnetic wave signals generated by the transceiver 105, they are noise or interference signals. To avoid mistakenly identifying interference as genuine human movement, a noise floor is established to encapsulate the highest amplitude of the environment signals received. The noise floor is then taken into the motion detection analysis by the processor 105 to eliminate false movement detection.

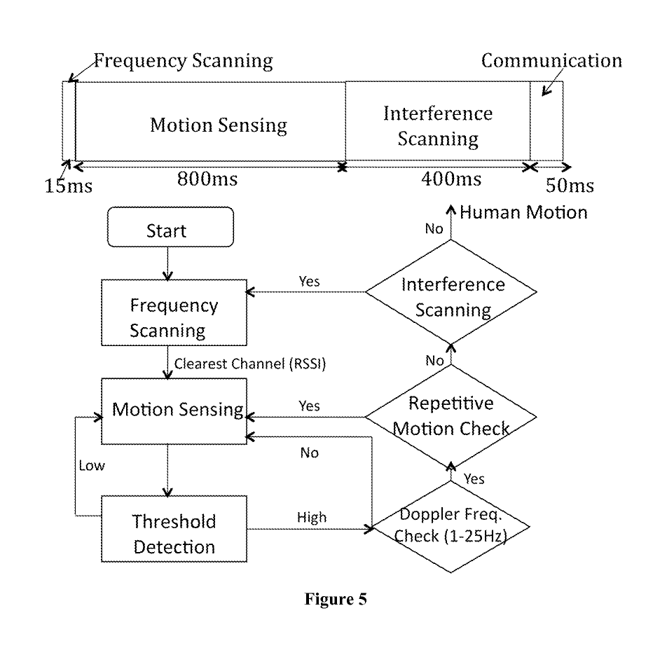

FIG. 5, depicts an embodiment of the wireless communication system with motion sensing function that executes the foregoing four operations serially in a particular system time period (such as a frame), allocating 15 ms for environment frequency scanning, then 800 ms for motion sensing, followed by 400 ms for interference detection, and finally 50 ms for data communication. The cycle begins with environment frequency scanning With the clearest frequency channel selected for the carrier signal for motion detection, the system turns to motion sensing. The system can set an amplitude threshold such that only received signals with an amplitude higher than the threshold will be considered as electromagnetic wave signals reflected from surfaces of objects detected in the detection area. Once such a signal is received and Doppler signal is generated, the system verifies the Doppler frequency to be within 1-25 Hz to ensure human movements were detected, otherwise the system continues the motion sensing operation. The system can also be configured to check for repetitive motion. In this case, even when a human movement is detected, the system continues the motion sensing operation. Lastly, the system detects interference to eliminate false movement detection.

The embodiments disclosed herein included a processor that may be implemented using a general purpose or specialized computing device, computer processor, or electronic circuitry including but not limited to a digital signal processor (DSP), application specific integrated circuit (ASIC), a field programmable gate array (FPGA), and other programmable logic device configured or programmed according to the teachings of the present disclosure. Computer instructions or software codes running in the general purpose or specialized computing device, computer processor, or programmable logic device can readily be prepared by practitioners skilled in the software or electronic art based on the teachings of the present disclosure.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for sensing motion and performing wireless communication, comprising:
one or more antennas for transmitting and receiving wireless data communication signals and motion detection electromagnetic waves;
a transceiver having a signal generator and a modulator, the transceiver configured to generate modulated RF signals for the wireless data communication, the transceiver being further configured to generate un-modulated RF carrier signals for the motion detection;
a motion sensor receiver for receiving motion detection electromagnetic waves that have been transmitted by the transceiver, reflected by one or more objects or persons, and received by the one or more antennas;
one or more electrical switches for switching between a first electrical path activating at least wireless data communication and a second electrical path activating at least motion detection, the one or more electrical switches being responsive to control signals such that a unit period of system operation is divided into at least one portion of time with the one or more switches configured for wireless data communication along the first electrical path and another portion of time with the one or more switches configured for motion detection along the second electrical path;
one or more processors for generating control signals for the one or more electrical switches and for processing motion detection electromagnetic wave data from the motion sensor receiver and processing wireless communication data to and from the transceiver, and providing control signals to the transceiver.

2. The system of claim 1 wherein the one or more electrical switches further configures a third electrical path for scanning a surrounding environment for available frequencies and selecting an appropriate frequency for generating the motion detecting electromagnetic waves.

3. The system of claim 1, wherein the motion sensor receiver comprises a mixer and a filter.

4. The system of claim 1, wherein the motion detection electromagnetic wave data from the motion sensor receiver is a Doppler signal derived from a Doppler effect of moving objects reflecting electromagnetic waves.

5. The system of claim 1, wherein the transceiver comprises a single communication port for both transmitting and receiving RF signals.

6. The system of claim 1, wherein the transceiver signal generator includes a local oscillator.

7. The system of claim 2 wherein the one or more processors further control detection of interference signals by recognizing a surrounding environment noise floor in a detection area.

8. A system for sensing motion and performing wireless communication, comprising:
one or more antennas for transmitting and receiving wireless data communication signals and motion detection electromagnetic waves;
a transceiver having a signal generator and a modulator, the transceiver configured to generate modulated RF signals for the wireless data communication, the transceiver being further configured to generate un-modulated RF carrier signals for the motion detection electromagnetic wave signals;
a motion sensor receiver for receiving motion detection electromagnetic waves that have been transmitted by the transceiver, reflected by one or more objects or persons, and received by the one or more antennas;
one or more electrical switches for switching between a first electrical path activating at least wireless data communication and a second electrical path activating at least motion detection, the one or more electrical switches being responsive to control signals such that a unit period of system operation is divided into at least one portion of time with the one or more switches configured for wireless data communication along the first electrical path and another portion of time with the one or more switches configured for motion detection along the second electrical path; and
one or more processors for processing motion detection electromagnetic wave data, processing wireless communication data to and from the transceiver, providing control signals the one or more electrical switches, and providing control signals to the transceiver;
wherein the system is configured to participate in a wireless network to communicate with one or more electrical appliances or devices with wireless communication functions such that when the system detects motion, the system transmits wireless data to the one or more electrical appliances or devices to control the operations of the one or more electrical appliances or devices.

9. A method for sensing motion and performing wireless communication, comprising:
transmitting and receiving, by one or more antennas, wireless data communication signals and motion detection electromagnetic waves;
generating by a transceiver having a signal generator and a modulator, modulated RF signals for the wireless data communication, and generating un-modulated RF carrier signals for the motion detection;
sensing, with a motion sensor receiver, received motion detection electromagnetic waves that have been transmitted by the transceiver, reflected by one or more objects or persons, and received by the one or more antennas;
configuring a first electrical path activating at least wireless data communication and a second electrical path activating at least motion detection using one or more configurable switches responsive to control signals such that a unit period of system operation is divided into at least one portion of time with the one or more switches configured for wireless data communication along the first electrical path and another portion of time with the one or more switches configured for motion detection along the second electrical path;
processing, by one or more processors, motion detection electromagnetic wave data received by the motion sensor receiver, processing wireless communication data to and from the transceiver, and sending control signals to the one or more electrical switches and to the transceiver.

10. The method of claim 9, wherein the motion detection electromagnetic wave data from the motion sensor receiver is a Doppler signal derived from Doppler effect of moving objects reflecting electromagnetic wave.

11. The method of claim 9 further comprising scanning a surrounding environment for available frequencies and selecting an appropriate frequency for generating the motion detecting electromagnetic waves.

12. The method of claim 11 wherein the one or more processors further control detection of interference signals by recognizing a surrounding environment noise floor in a detection area.
